(19) United States
(12) Patent Application Publication
(10) Pub. No.: US 2015/0120459 A1
(43) Pub. Date: Apr. 30, 2015

(54) INTERCONNECTED PLATFORMS FOR PROVIDING ADVERTISEMENTS

(71) Applicant: COX COMMUNICATIONS, INC., Atlanta, GA (US)

(72) Inventors: Michael R. Zeigler, Atlanta, GA (US); Dorothy N. Buie, Atlanta, GA (US); Leslie H. Talansky, Atlanta, GA (US); William F. Farina, Atlanta, GA (US)

(73) Assignee: COX COMMUNICATIONS, INC., Atlanta, GA (US)

(21) Appl. No.: 14/164,920

(22) Filed: Jan. 27, 2014

Related U.S. Application Data
(63) Continuation-in-part of application No. 14/065,604, filed on Oct. 29, 2013.

(51) Int. Cl. G06Q 30/02; H04N 21/81; H04N 21/262; H04N 21/2543; H04N 21/2547

(52) U.S. Cl. CPC G06Q 30/0264; G06Q 30/0205; G06Q 30/0206; H04N 21/25435; H04N 21/2547; H04N 21/26241; H04N 21/812
USPC 705/14.61

(57) ABSTRACT

Systems and methods for selling unsold ad (advertisement) avails as individual ad avails or as bundled with other unsold ad avails in a demographic bin. Ad avails and ad demographic bins may be sold to an ad buyer and may represent a variety of parameters and/or terms to which the ad demographic bin seller may have to perform. The ad demographic bins may specify a number of views, a targeted geography of those views, and/or a targeted demographic of those views. The unsold ad avails may be offered for sale without indicating the content, content providers, or the time slot associated with the ad avail. These ad avails may be offered for sale if it is determined that the ad avails are about to expire, such as within a threshold number of days. In the cases, where the ad avails are sold as a demographic bin (i.e. bundled with other ad avails), the aggregate demographic parameters associated with the demographic bin may be indicated when offering the ad avails for sale. Once an ad demographic bin is sold, one or more ad avails, spots, and/or other ad assets may be acquired, such as from media and/or content providers for the purpose of rendering one or more ads on behalf of the ad buyer. The ad avails, spots, and/or other ad assets may be selected and/or acquired in a manner as to perform to the parameters of the ad demographic bin.

### CROSS-REFERENCE TO RELATED APPLICATIONS

This application is a continuation-in-part of U.S. patent application Ser. No. 14/065,604 filed Oct. 29, 2013, the entire contents of which are incorporated by reference herein.

### TECHNICAL FIELD

This disclosure generally relates to interconnected platforms for providing advertisements.

### BACKGROUND

Advertising is often sold and displayed before, during, and/or after providing and/or rendering media content, such as audio and/or video, to a consumer of the of the media content. This advertising may be provided and/or sold for rendering by media providers. An example of a prior art mechanism for providing and/or selling advertisements (ads) is depicted in FIG. 1. FIG. 1 is a simplified schematic diagram of an example prior art environment 100 for selling advertisements by an ad broker 110 to a variety of ad buyers 120(1), 120(N), hereinafter individually or collectively referred to as ad buyer(s) 120. The ads may be sold by the ad broker 110 as spots 122 sold to the ad buyer 120.

The spots 122 may be associated with a particular multiple-system operator (MSO) 124(1), 124(N), hereinafter individually or collectively referred as an MSO 124. Therefore, the ad broker 110 may be serving as an intermediary between one or more MSOs and one or more ad buyers 120 to sell spots 122. The spots 122 that are sold may further be associated with a particular geographic location 126, 128, such as where a corresponding MSO 124 has network coverage. The spots 122 sold to the ad buyers 120 may correspond to a time slot 130, 132, 134, 136, 138, 140 on a particular channel 150, 152. Therefore, when an ad buyer 120 purchases a spot 122 from the ad broker 110, the ad buyer can insert an ad impression in that purchased spot 122 on the particular channel 150, 152 and time slot 130, 132, 134, 136, 138, 140 corresponding to the spot 122 sold by the ad broker 110 and purchased by the as buyer 120.

The spots 122, as they are associated with a particular channel 150, 152, time slot 130, 132, 134, 136, 138, 140, and geography 126, 128, may generally be monetized effectively for particular channels 160, such as channels 162 with relatively high viewership versus channels 164 with a relatively lower viewership. In some cases, ad buyers may not be amenable to place ads, or otherwise purchase ad slots on the channels with relatively lower viewership.

### BRIEF DESCRIPTION OF THE FIGURES

Reference will now be made to the accompanying drawings, which are not necessarily drawn to scale, and wherein:

FIG. 1 is a simplified schematic diagram illustrating a prior art mechanism of buying and selling advertisement spots between an advertisement broker and one or more advertisement buyers.

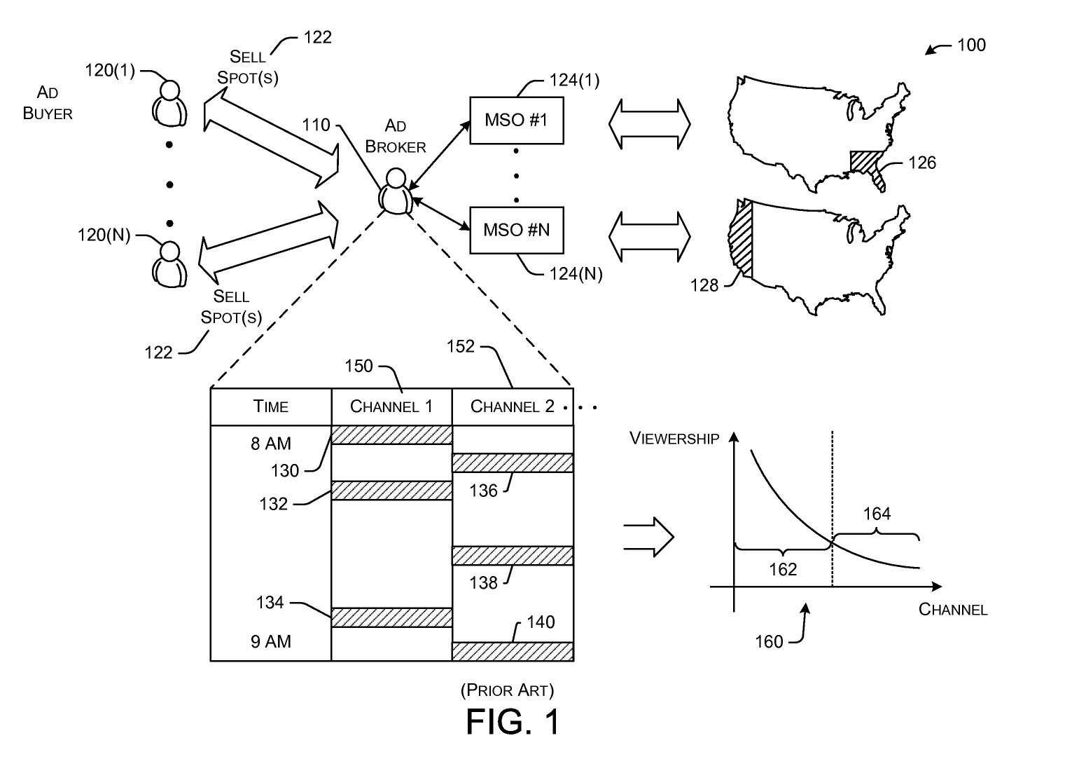

FIG. 2 is a simplified schematic diagram illustrating an example environment for providing an ad demographic bin, in accordance with example embodiments of the disclosure.

FIG. 3 is a simplified block diagram illustrating an example architecture of an ad broker interconnect system, in accordance with example embodiments of the disclosure.

FIG. 4 is a flow diagram illustrating an example method for providing ad demographic and/or geographic bins, in accordance with certain example embodiments of the disclosure.

FIG. 5 is a flow diagram illustrating an example method for generating one or more demographic and/or geographic bin, in accordance with certain example embodiments of the disclosure.

FIG. 6 is a schematic diagram illustrating an example environment with an ad demographic bin sales transaction and advertising in according to the transacted demographic bin, in accordance with certain example embodiments of the disclosure.

FIG. 7 is a flow diagram illustrating an example method for remnant bundling and selling unbundled ad avails, in accordance with example embodiments of the disclosure.

FIG. 8 is a flow diagram illustrating an example method for receiving an indication of an unbundled ad avail and selling the ad avail, in accordance with example embodiments of the disclosure.

FIG. 9 is a schematic diagram illustrating and example environment for transacting an unbundled ad avail and/or remnant bin sale, according to example embodiments of the disclosure.

### DETAILED DESCRIPTION OF EMBODIMENTS OF THE INVENTION

Embodiments of the disclosure are described more fully hereinafter with reference to the accompanying drawings, in which example embodiments of the disclosure are shown. This disclosure may, however, be embodied in many different forms and should not be construed as limited to the example embodiments set forth herein; rather, these embodiments are provided so that this disclosure will be thorough and complete, and will fully convey the scope of the invention to those skilled in the art. Like numbers refer to like, but not necessarily the same or identical, elements throughout.

Example embodiments of the disclosure may provide systems, apparatus, and methods for transacting advertisement (ad) demographic bins (also referred to as ad demographic and/or geographic bins). The ad demographic bins that are transacted may correspond to a particular number of impressions, views, interactions, estimated impressions, views, and/or interactions with an ad associated with a particular ad bin. The ad demographic bins may further target a particular demographic group and/or particular geographic location(s) for the number of impressions, views, and/or interactions associated with the ad bin transacted. Furthermore, when an ad demographic bin is transacted, the numeric viewership, demographic, and geographic delivery of those ads may be provided across a variety of channels, content types, and number of spots and/or impressions.

Example embodiments of the disclosure may further provide systems, apparatus, and methods for transacting ad avails that are not bundled into a demographic bin and may be “left-over” or remnant ad avails after some demographic bins and/or individual spots have been created and sold to ad buyers. In one aspect, an indication of available ad avails, or other ad assets may be provided by content providers. These ad avails may, in certain embodiments, be ad avails that are relatively soon-to-expire. In other words, the ad avails may be in time slots that are relatively imminently approaching, such as in two days, or in one day. It may be desirable for content providers to sell these ad avails quickly to prevent the situation of not selling those slots at all. In some example cases, the remnant ad avails may be sold as individual ad avails and in other example cases, a collection of remnant ad avails may be bundled into a remnant bin to be sold to ad buyers. In another sense, since ad avails are a perishable resource, any ad avails that are soon to expire, are difficult to sell, or may not easily be bundled into an ad bin, may be presented for sale to ad buyers. In some example embodiments, ad buyers may receive advantageous pricing of the remnant ad avails compared to other spots and/or demographic bins acquired by the ad buyers. In some of these example cases, the ad sellers (content providers) may be motivated to sell the left-over ad avails at discounted prices. In example embodiments, the remnant ad avails may be ad avails that are unsold and within a threshold time of expiration.

In some example embodiments, when the remnant ad avails are identified and offered for sale, exact details of the remnant ad avail may not be identified to the potential ad buyers. For example, the channel, content, media type, and/or time slot of the remnant ad avail may not be identified to the ad buyer. Instead, demographical and/or geographical information associated with the remnant ad avail, such as information associated with the associated content, may be provided while soliciting the sale of the remnant ad or a remnant bin including the remnant ad. The demographical and/or geographical information may be identified by a variety of mechanisms. For example, the demographical and/or geographical information may be communicated by the content provider and systems associated therewith when providing an indication of an inventory of remnant ad avails available for reservation and/or sale. In example embodiments, a demographical and/or geographical information associated with a collection of remnant ads may be combined and a remnant ad bin associated with that collection of remnant ads may be offered for sale. Again, in certain example embodiments, instead of specifying the exact constituent ad avail assets (i.e. remnant add avails) of the remnant bin, the aggregated demographical and/or geographical parameters associated with the remnant bin may be presented to potential ad buyers. In some of these example cases, the constituent ad avail assets of a particular remnant bin may be communicated to a purchaser of the remnant bin only after the remnant bin has been purchased. In example embodiments, upon purchase of the remnant ad avail or the remnant bin, the remnant ad avail or the constituent remnant ad avails of the remnant bin, respectively, may be purchased and/or reserved on behalf of the ad buyer.

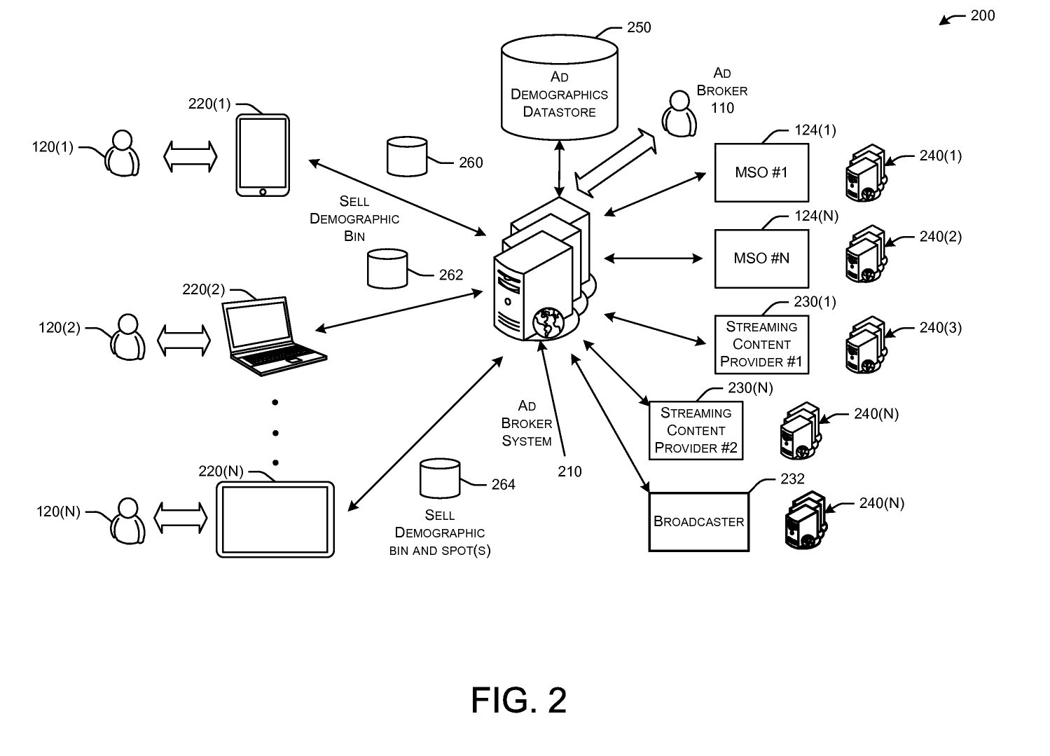

FIG. 2 is a simplified schematic diagram illustrating an example environment 200 for providing an ad demographic bin, in accordance with example embodiments of the disclosure. The environment 200 may include the ad broker 110 that may be able to interact with an ad broker interconnect system 210. Ad buyers 120 may further be able to interact with the ad broker interconnect system 210 via his/her user device 220(1), 220(2), . . . 220(N), hereinafter referred to collectively or individually as user device 220. The ad broker interconnect system 210 may further be configured to interact with one or more content providers, such as MSOs 124 and/or streaming content providers 230(1), . . . 230(N), hereinafter referred to collectively or individually as streaming content providers 230, or one or more broadcasters 232. The content providers 124, 230, 232 may have corresponding respective content provider servers 240(1), 240(2), 240(3), . . . 240(N), hereinafter referred to collectively or individually as service provider servers 240. The ad broker interconnect system 210 may further be communicatively coupled to an ad demographic datastore 250 that may contain ad related information for that may be received from the content provider servers 240 and/or other ad data sources, such as content viewership reporting services.

The user devices 220 may be any suitable device used by the ad buyers 120 and configured to communicate with the ad broker interconnect system 210 including, but not limited to tablet computing devices, electronic book (ebook) readers, netbook computers, notebook computers, laptop computers, desktop computers, server systems, personal digital assistants (PDA), smart phones, web-enabled televisions, video game consoles, set top boxes (STB), digital video recorder (DVR) systems, combinations thereof, or the like. The user devices 220 may be used by ad buyers 120 for a variety of purposes, such as interacting with the ad broker interconnect system 210 and/or the ad broker 110 to facilitate the purchase of ad demographic bins, view the distribution of spots and/or impressions associated with ad demographic bins, purchase ad spots and/or impressions, combinations thereof, or the like.

The user devices 220 may be configured to communicate with the ad broker interconnect system 210 via one or more networks that may include any one or a combination of different types of suitable communications networks, such as cable networks, the Internet, wireless networks, cellular networks, and other private and/or public networks. Furthermore the networks may include any variety of medium over which network traffic is carried including, but not limited to, coaxial cable, twisted wire pair, optical fiber, hybrid fiber coaxial (HFC), microwave terrestrial transceivers, radio frequency communications, satellite communications, or combinations thereof.

In example embodiments the content provider servers 240 may be one or more media provider servers, such as, for example, a video back office (VBO) server or a streaming media server. The content provider servers 240 may, in certain example embodiments, be configured to provide a variety of statistics to the ad broker interconnect system 210. These statistics may be communicated from the content provider servers 240 via one or more networks as described above. The statistics may include information such as viewership or predicted viewership of a particular content channel associated with a particular content provider 124, 230, 232 and/or interactions or predicted interaction with a particular ad. For example, a particular MSO 124 and its associated content provider server 240 may be configured to provide statistics associated with past viewership of one or more content channels. In some cases, these viewership statistics may be provided for individual media content and/or shows. In another example, a particular MSO 124 and associated content provider server 240 may be configured to provide viewership statistics associated with video-on-demand (VOD) or pay-per-view content. In yet another example, a particular streaming content provider 230 and its associated content provider server 240 may be configured to provide updated statistics on the number of views of a particular media content. In still another example, a particular streaming content provider 230 and its associated content provider server 240 may be configured to provide information related to user interactions, such as click-through, associated with a displayed ad. In these aforementioned examples, the content provider servers 240 may be configured to provide demographic information associated with the viewership statistics provided. This demographic information may be related to a variety of suitable identifiers associated with viewers of a particular content and/or channel of a content provider 124, 230, 232. Such identifiers may include, but is not limited to, number of people in a viewer's household, gender of the viewers, age of the viewers, race of the viewers, religion of the viewers, sexual orientation of the viewers, political views of the viewers, product or service preferences of viewers, combinations thereof, or the like. For example, a particular content provider server 240 may be configured to identify and/or report that a particular media content may have 4 million viewers, of which 70% are men and 30% are female. In another example, a particular content provider server 240 may be configured to identify and/or report that a particular channel may have 2 million teenage viewers and 1 million viewers that are not teenagers. In yet another example, a particular content provider server 240 may be configured to identify and/or report that a particular channel may have 1 million viewers that are golf enthusiasts.

The content provider servers 240 may further be configured to receive orders and/or reservation of ad spots and/or impressions. For example, a particular content provider server 240 may be configured to receive a reservation and/or order for an ad spot at a particular time, particular channel, and/or particular geography of the MSO 124 associated with the content provider server 240. In another example, a particular streaming content provider 230 and its associated content provider server 240 may be configured to receive an order for a particular number of impressions associated with one or more particular content provided by the associated streaming content provider 230. In yet another example, a broadcast content provider 232 and its associated content provider server 240 may be configured to receive a reservation and/or an order a reservation of an ad spot at a particular time, particular channel, and/or particular geography. In example embodiments, reservations and/or purchases of ad spots, impressions, and/or avails may be received by the content provider servers 240 from the ad broker interconnect system 210.

According to example embodiments, the ad broker interconnect system 210 may be configured to identify one or more demographic bins 260, 262. The demographic bin 260, 262 may identify a particular number of ad impressions and/or predicted ad views. The demographic bin 260, 262 may also be associated with a particular demographic of viewers. Further, the demographic bins may be associated with a particular geography. For example, a demographic bin may be identified as impressions or views to 5 million women between the ages of 25 to 34 on the west coast of the United States of America. Another example demographic bin may include 2 million golf-enthusiasts in all of Europe. Yet another example demographic bin may include 20 million children between the ages of 2 and 9 throughout the United States of America.

The ad broker interconnect system 210 may be configured to provide (e.g. sell) one or more demographic bins 260, 262 to one or more ad buyers 120 via their user devices 220. Selling the demographic bin may result in the ad broker interconnect system 210 and the ad broker 110 supplying to the ad buyer 120 the ad based parameters associated with that demographic bin via the rendering of one or more target ad(s) by the content providers 124, 230, 232. In other words, the ad broker system 110 may provision one or more spots, avails, and/or impressions of ads on the content providers 124, 230, 232 to meet the ad based agreements associated with the demographic bins 260, 262 sold to the ad buyers 120. In certain example embodiments, the ad broker 110 by selling an ad demographic bin 260, 262 to a particular ad buyer 120, may be obligated to perform to the terms of that ad demographic bin 260, 262 by delivering the numerical and demographical targets parameterized with the sold ad demographic bin 260, 262. The ad broker 110 and the ad broker system 210 may provide the numerical and demographical targets by provisioning one or more spots, impressions, and/or avails with one or more content providers 124, 230, 232 on behalf of the ad buyer 120. According to some further example embodiments of the disclosure, the ad broker interconnect system 210 may also be configured to provide (e.g. sell) both ad demographic bin(s), as well as individual spots and/or impressions 264.

These concepts may be better understood by way of examples. As a non-limiting example, consider that a particular ad buyer 120 purchases a demographic bin that includes 10 million views by men between the ages of 17 and 39 in the United States of America to show a 30 second ad. In certain example embodiments, by selling this demographic bin, the ad broker interconnect system 210 may be required to provide 10 million views of the 30 second ad to men between the ages of 17 and 39 spread across the United States. In some example cases, the ad broker interconnect system 210 may collect payment for the demographic bin 260, 262 sold to the ad buyer 120 prior to performing to the terms and/or parameters of the demographic bin. In certain other example cases, the ad broker interconnect system 210 may collect payment for the demographic bin 260, 262 sold to the ad buyer 120 after performing to the terms and/or parameters of the demographic bin.

Continuing with the example, the ad broker interconnect system 210 along with the ad broker 110 may acquire a combination of one or more spots with the MSOs 124, spots with the broadcasters 232, and/or impressions with streaming content providers 230 where the 30 second ad may be rendered to meet the terms of the example ad demographic bin. In one example, this may be accomplished by purchasing spots on multiple MSOs 124, the combination of which have a geographic reach throughout the United States of America, such as spots associated with content generally viewed by the target demographic. The spots acquired may total an expected viewership of 10 million men between the ages of 17 and 39. In another example of the ad broker interconnect system 210 performing to the example demographic bin, impressions prior to and/or during streaming media delivery of relatively male oriented content (i.e. sports, cars, men's health, etc. related content) may be acquired from one or more streaming content providers 230 along with spots across the United States of America on similar male oriented content on one or more MSOs 124 and/or broadcasters 232. The combination of the acquired spots and/or streaming media impressions may result in a sum of 10 million expected views by males between the ages of 17 to 39.

In certain example embodiments, the ad broker interconnect system 210 may provide payment for the acquired spots and/or impressions on the variety of content providers 124, 230, 232 upon acquiring the spots and/or impressions and prior to rendering the ad during those acquired spots and/or when the number of impressions have been met/delivered. In certain other example embodiments, the ad broker interconnect system 210 may provide payment for the acquired spots and/or impressions on the variety of content providers 124, 230, 232 only after the ad has been rendered during those acquired spots and/or when the number of impressions have been met/delivered. It will be appreciated that in certain example embodiments, the cost of acquiring the spots and/or impressions on the variety of content providers 124, 230, 232 by the ad broker 110 may be relatively less than the revenue generated by selling the corresponding demographic bin, resulting in a profit for the ad buyer 110.

It will be appreciated that there may be substantial overlap in the viewership demographics associated with certain content provided by the content providers. For example, a channel may have a 70% viewership by males and 30% viewership by females. This particular channel may be bundled in an ad demographic bin targeting men in some cases and in an ad demographic bin targeting women in other cases. However, in cases such as this, an ad broker interconnect system 210 may be configured to determine that allocating spots in this particular channel to ad demographic bins associated with men may be a relatively more effective way to achieve the delivery of the conditions of a plurality of ad demographic bins sold across a plurality of ad buyers 120. In other words, the systems and methods disclosed herein may, in certain example embodiments, inherently encourage an ad broker 110 and/or an ad broker interconnect system 210 to efficiently target ad assets (avails, impressions, spots, etc.) to ad buyers' 120 numerical and/or demographical requirements. The targeting and/or associating ad assets to ad demographical bins may be performed based on a variety of viewership data, such as viewership data that may be received, managed, analyzed, and/or stored, such as in the ad demographics datastore 250, by the ad broker interconnect system 210. In certain example embodiments, the variety of viewership data may be received by the ad broker interconnect system 210 from the content providers 124, 230, 232, and/or associated content provider servers 240. In other example embodiments, the variety of viewership data may be received by the ad broker interconnect system 210 from one or more third party sources, such as The Nielsen Company®.

In some example embodiments, the allocation of ad assets to ad demographic bins may involve one or more algorithms to optimize and/or pseudo-optimize the effectiveness, such as the monetization, of a collection of ad assets. These algorithms may include a variety of regression analysis, linear regression analysis, artificial intelligence algorithms, filtering algorithms, a variety of heuristics, principal component analysis, combinations thereof, or the like. In some example cases, the allocation of ad assets to ad demographic bins may be based at least in part on the current prices of particular ad demographic bins. As the prices, of ad demographic bins may be quite dynamic based on current supply and demand of those ad demographic bins, it will be appreciated that the allocation of ad assets to particular demographic bins may also be relatively dynamic and may vary with time. In other example cases, the algorithms for allocation of ad assets to ad demographic bins may further consider and/or optimize the monetization of ad assets associated with the channels with relatively lower viewership 164, as that may provide greater incremental revenue from available ad assets. In yet further example cases, the algorithms for allocation of ad assets to ad demographic bins may further consider and/or optimize based at least in part on the current availability and pricing to ad assets. For example, if a price-per-view for a male viewer is relatively lower on the Discovery Channel® relative to ESPN®, then the ad broker interconnect system 210 may determine that it may be more effective to allocate Discover Channel® spots versus ESPN® spots to an ad demographic bin that specifies male viewers until doing so brings about rationalization and/or parity of cost between the two choices of this example.

It will be further appreciated that when the ad broker interconnect system 210 acquires targeted spots and/or impressions, channels with relatively lower viewership 164 and/or content with relatively lower viewership may be more effectively targeted by the demographic bins mechanism, rather than by ad buyers 120 purchasing individual spots. In other words, an individual ad buyer 120 may not have the time and/or the resources to analyze much of the content and/or channels with relatively low viewership to place spots and/or impressions thereon. However, if the ad buyer 120 identifies a target demographic and purchases a demographic bin for rendering their ad in accordance with that demographic bin, then the task of distributing the rendering of their ad and the demographic targeting may be performed by the ad broker interconnect system 210. Therefore, the burden of having to distribute the ad rendering by the ad buyer 120 over a variety of channels and/or content may be reduced. Furthermore, the ad broker interconnect system 210 may be able include more of the channels with relatively lower viewership and/or content of relatively lower viewership in the assembly of the ad demographic bins offered for sale to the ad buyers 120 by the ad broker 110. In some cases, the systems and methods as described herein may provide for a better distribution and/or usage of advertising opportunities on the relatively lower viewership channels 164 and/or content. This may especially be true compared to systems where individual users may have to purchase spots from individual content distributers 124, 230, 232. Therefore, in some cases, the advertising avails associated with the relatively lower viewership channels 164 and/or relatively lower viewership content may be better monetized from an advertising standpoint.

It will still further be appreciated that the ad broker 110 and the ad broker interconnect system 210 serves as an interconnect between a variety of media and/or content vectors, each with a variety of content and/or channels, providing content across a variety of geographies, and with viewers with a variety of a variety of interests and demographic profiles. As such, the ad broker 110 and the ad broker interconnect system 210 are configured to provide a package of targeted ad delivery solutions across a wide variety content types, content providers, geographies, and viewers. The ad broker 110 and the ad broker interconnect system 210 is further configured to serve as an interconnect with a variety ad buyers 110. As a result, of the relatively high number of as buyers 110 purchasing ad demographic bins 260, 262 from the ad broker 110, there may be more accurate and/or rational pricing of advertising spots, impressions, and/or avails. Additionally, the systems and methods described herein may provide for greater liquidity in the purchase and sales of ad related inventory. Further still, the ad broker 110 and the ad broker interconnect system 210 may, in certain example embodiments, have a relatively high level of flexibility for managing ad avail inventory (i.e. dynamic allocation of ad avail assets), compared to a mechanism that may provide only for spot and/or impression sales (i.e. static sales and commitment of ad avail assets).

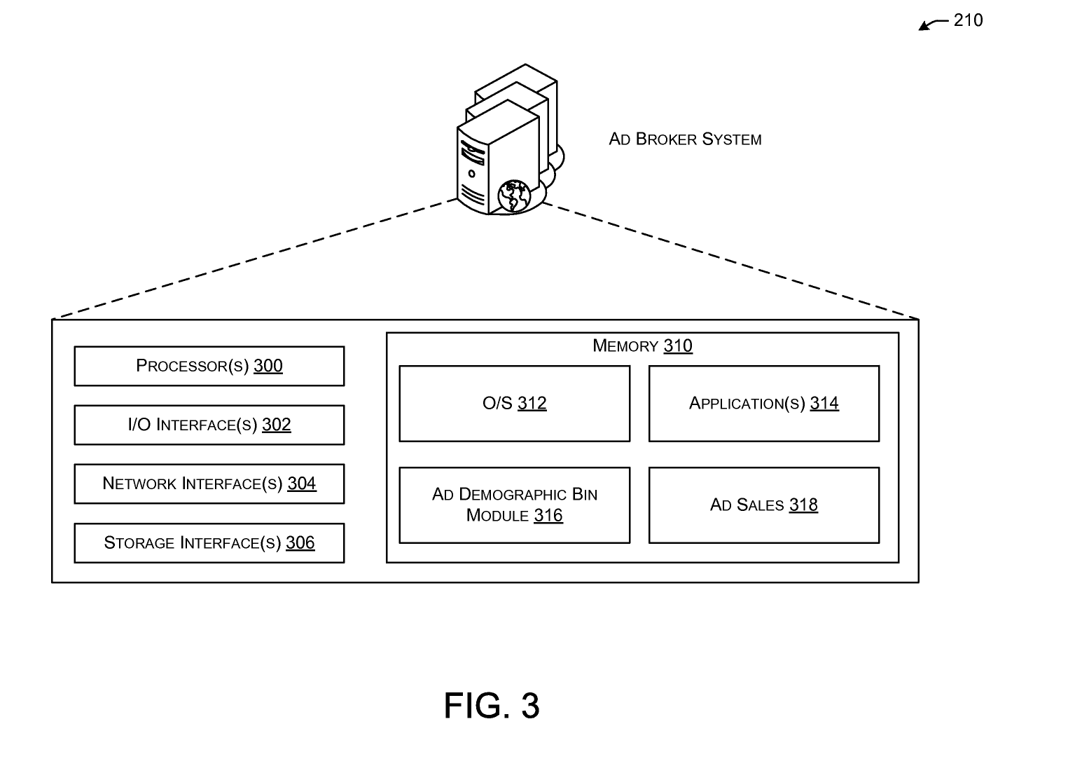

The architecture of the ad broker interconnect system 210 may be better understood with reference to FIG. 3. FIG. 3 is a simplified block diagram illustrating an example architecture of the ad broker interconnect system 210, in accordance with example embodiments of the disclosure. The ad broker interconnect system 210 may include one or more processors 300, one or more input/output (I/O) interfaces 302, one or more network interfaces 304, and one or more memories 310.

The one or more I/O device interfaces 302 may enable the use of one or more (I/O) device(s) or user interface(s), such as a keyboard and/or mouse. An ad broker 110 may be able to administer the systems and methods disclosed herein by interacting with ad broker interconnect system 210 via the I/O device interfaces 302. The network interfaces(s) 304 may allow the ad broker interconnect system 210 to communicate via the one or more network(s) and/or via other suitable communicative channels. In example embodiments, the network interfaces 304 may enable the ad broker interconnect system 210 to communicate with one or more content provider servers 240 and/or user devices 220 via one or more networks, such as the Internet. The storage interfaces 306 may enable the ad broker interconnect system 210 to communicate and/or use one or more storage devices, such as, for example the ad demographics datastore 250.

The processors 300 of the ad broker interconnect system 210 may be implemented as appropriate in hardware, software, firmware, or combinations thereof. Software or firmware implementations of the processors 300 may include computer-executable or machine-executable instructions written in any suitable programming language to perform the various functions described. Hardware implementations of the processors 300 may be configured to execute computer-executable or machine-executable instructions to perform the various functions described. The one or more processors 300 may include, without limitation, a central processing unit (CPU), a digital signal processor (DSP), a reduced instruction set computer (RISC), a complex instruction set computer (CISC), a microprocessor, a microcontroller, a field programmable gate array (FPGA), or any combination thereof. The ad broker interconnect system 210 may also include a chipset (not shown) for controlling communications between one or more processors 300 and one or more of the other components of the ad broker interconnect system 210. The processors 300 may also include one or more application specific integrated circuits (ASICs) or application specific standard products (ASSPs) for handling specific data processing functions or tasks.

The memory 310 may include one or more volatile and/or non-volatile memory devices including, but not limited to, magnetic storage devices, read only memory (ROM), random access memory (RAM), dynamic RAM (DRAM), static RAM (SRAM), synchronous dynamic RAM (SDRAM), double data rate (DDR) SDRAM (DDR-SDRAM), RAM-BUS DRAM (RDRAM), flash memory devices, electrically erasable programmable read only memory (EEPROM), non-volatile RAM (NVRAM), universal serial bus (USB) removable memory, or combinations thereof.

The memory 310 may store program instructions that are loadable and executable on the processor(s) 300, as well as data generated or received during the execution of these programs. Turning to the contents of the memory 310 in more detail, the memory 310 may include one or more operating systems (O/S) module 312, an applications module 314, an ad demographic bin module 316, and an ad sales module 318. Each of the modules and/or software may provide functionality for the ad broker interconnect system 210, when executed by the processors 300. The modules and/or the software may or may not correspond to physical locations and/or addresses in memory 310. In other words, the contents of each of the modules 312, 314, 316, 318 may not be segregated from each other and may, in fact be stored in at least partially interleaved positions on the memory 310.

The O/S module 312 may have one or more operating systems stored thereon. The processors 300 may be configured to access and execute one or more operating systems stored in the (O/S) module 312 to operate the system functions of the ad broker interconnect system 210. System functions, as managed by the operating system may include memory management, processor resource management, driver management, application software management, system configuration, and the like. The operating system may be any variety of suitable operating systems including, but not limited to, Google® Android®, Microsoft® Windows®, Microsoft® Windows® Server®, Linux, Apple® OS-X®, or the like.

The application(s) module 314 may contain instructions and/or applications thereon that may be executed by the processors 300 to provide one or more functionality associated with the aggregation of ad assets into ad demographic bins, sales of demographic bins, and procurement of ad assets to fulfill the terms of the sold ad demographic bins. These instructions and/or applications may, in certain aspects, interact with the (O/S) module 312 and/or other modules of the ad broker interconnect system 210. The applications module 314 may have instructions, software, and/or code stored thereon that may be launched and/or executed by the processors 300 to execute one or more applications and functionality associated therewith. These applications may include, but are not limited to, functionality such as web browsing, business, communications, graphics, word processing, publishing, spreadsheets, databases, gaming, education, entertainment, media, project planning, engineering, drawing, or combinations thereof.

The ad demographic bin module 316 may have instructions stored thereon that, when executed by the processors 300, enable the ad broker interconnect system 210, to perform various functions related to creating ad demographic bins 260, 262, associating ad assets to the created ad demographic bins 260, 262, and performing to the parameters of the ad demographic bins 260, 262. The processors 300 may be configured to name and/or assign parameters to create an ad demographic bin. This ad demographic bin 260, 262 may have one or more parameters that identify the delivery of ad metrics and/or demographics to the owner and/or purchaser of the ad demographic bin 260, 262, such as the ad buyer 120. The parameters may include, for example, the number of ad views, the number of ad interactions, demographics associated with the viewers, and/or geography associated with the viewers. The demographics may include, for example, number of people in a viewer's household, gender of the viewers, age of the viewers, race of the viewers, religion of the viewers, sexual orientation of the viewers, political views of the viewers, product or service preferences of viewers, combinations thereof, or the like. In one sense, the processors, by creating the ad demographic bins may be configured to tie together numerical targets, demographical targets, and geographical targets.

The processors 300 may further be configured to associate one or more ad assets (e.g. spots, avails, impressions, etc.) available from the content providers 124, 230, 232 to a created and/or pre-existing ad demographic bin 260, 262. The ad assets may, therefore, be acquired by the processors 300 on behalf of the owner of the ad demographic bin 260, 262, such as the buyer of the ad demographic bin 260, 262. In certain example embodiments, the processors may be configured to dynamically allocate available ad assets to ad demographic bins sold to ad buyers 120. For example, when the ad buyer 120 wishes to render a particular ad, the processors 300 may identify an appropriate ad asset at that time to allocate to the ad buyer 120 and his/her purchased ad demographic bin. In other example embodiments, the processors 300 may be configured to pre-allocate ad assets to a particular ad demographic bin 260, 262 at the time of creating the ad demographic bin 260, 262. It will be appreciated that the processors 300 may be configured to optimize, such as by using a variety of algorithms, to provide the terms and parameters of the ad demographic bin 260, 262 by expending as little funds as possible to acquire the ad assets on behalf of the ad demographic bin 260, 262 owner, such as the ad buyer 120. In other words, the processors may be configured to identify arbitrage opportunities in ad assets, such as opportunities where particular demographic targets may be acquired for a relatively lower cost per view than other ad assets. In some cases, the processors 300 may be configured to identify arbitrage opportunities in the relatively lower viewed channels 164, leading to better monetization of viewers on those content channels and platforms. The processors 300, may yet further be configured to provide funding, or initiate funding, to the content providers 124, 230, 232 for the funding of ad assets acquired on behalf of the ad demographic bin purchaser, such as the ad buyer 120.

The processors 300 may yet further be configured to determine if the stipulated delivery parameters have been met. In other words, the processors 300 may be configured to determine if the number of views of a particular demographic and/or geography have been fulfilled. In some cases, the processors 300 may be configured to transmit a message to the ad buyer via his/her user device 220 via one or more networks to indicate to him/her that the terms of the ad demographic bin have been met.

The processors 300 may further be configured to identify one or more unsold ad avails and/or ad avails that have not been consumed in creating an ad demographic bin that is offered for sale. These remnant ad avails may be identified and offered for sale by the processors 300 and the ad broker interconnect system 210. In some cases, the processors 300 may be configured to receive an indication of these unsold remnant ad avails from the content providers 124, 230, 232. In other cases, the processors 300 may be configured to identify these available remnant ad avails based at least in part on an initial identification of available ad avails at the content providers 124, 230, 232 as well as knowledge of which ad avails have been packaged into ad demographic bins and sold as spot ad avails. In some example embodiments, the processors 300 may be configured to determine if the remnant ad avails are to expire within a threshold condition. In these example embodiments, the processors 300 may offer for sale those remnant ad avails for which the expiration (i.e. run time slot) satisfies a threshold condition. For example, the threshold condition may identify ad avails that will expire relatively soon, such as in two days or in one week. In some cases, the unsold and/or remnant ad avails may be offered for sale by identifying demographic and/or geographic parameters of the remnant ad avail. In some example embodiments, when the processors 300 offer the remnant ad avails for sale, the run time slots, associated content, and/or associated content provider 124, 230, 232 may not be identified in the solicitation for sale. In these cases, one or more of the demographic and/or geographic parameters associated with the remnant ad avail may be presented to potential buyers 120 of the remnant ad avail.

The processors 300 may still further be configured to execute the instructions stored in the ad demographic bin module 316 to generate a remnant demographic bin. The remnant ad demographic bin may be created by bundling two or more remnant or unsold ad avails. These remnant ad avails, as described above may be ad avails that are relatively imminently to expire (i.e. their run time slot is within a predetermined threshold time from the current time). The processors may be configured to offer the remnant bin for sale to the one or more ad buyers 120. In example embodiments, the processors 300 may aggregate demographic and/or geographic parameters of remnant ad avails to generate demographic information associated with the remnant bin constituted from the remnant ad avails. When the remnant bin is offered for sale, the processors 300 may indicate to the ad buyers 120 the demographic information of the remnant bin. In some example embodiments, the processors 300 may be configured to not provide an indication of the constituent ad avails of the remnant bin, such as the run time slots, associated content, and/or associated content provider 124, 230, 232 of the constituent remnant ad avails.

The ad sales module 318 may have instructions stored therein that may be executed by the processors 300 to provide functionality associated with selling ad demographic bins, including remnant bins. The processors 300 may present to an ad buyer 120 via his/her user device 220 and via one or more networks, such as the Internet, information associated with ad demographic bins available for purchase from the ad broker 110 and the ad broker interconnect system 210. In some example embodiments, the processors 300 may be configured to receive requests, such as potential target demographics and/or geography form the ad buyer 120 and create an ad demographic bin based thereon. The processors 300 may yet further be configured to receive funding, or initiate receipt of funding, from the ad buyer 120 for the acquisition of the ad demographic bin.

It will be appreciated that there may be overlap in the functionality of the instructions stored in the operating systems (O/S) module 312, the applications module 314, the ad demographic bin module 316, and the ad sales module 318. In fact, the functions of the aforementioned modules 312, 314, 316, 318 may interact and cooperate seamlessly under the framework of the ad broker interconnect system 210. Indeed, each of the functions described for any of the modules 312, 314, 316, 318 may be stored in any module 312, 314, 316, 318 in accordance with certain embodiments of the disclosure. Further, in certain embodiments, there may be one single module that includes the instructions, programs, and/or applications described within the operating systems (O/S) module 312, the applications module 314, the ad demographic bin module 316, and the ad sales module 318.

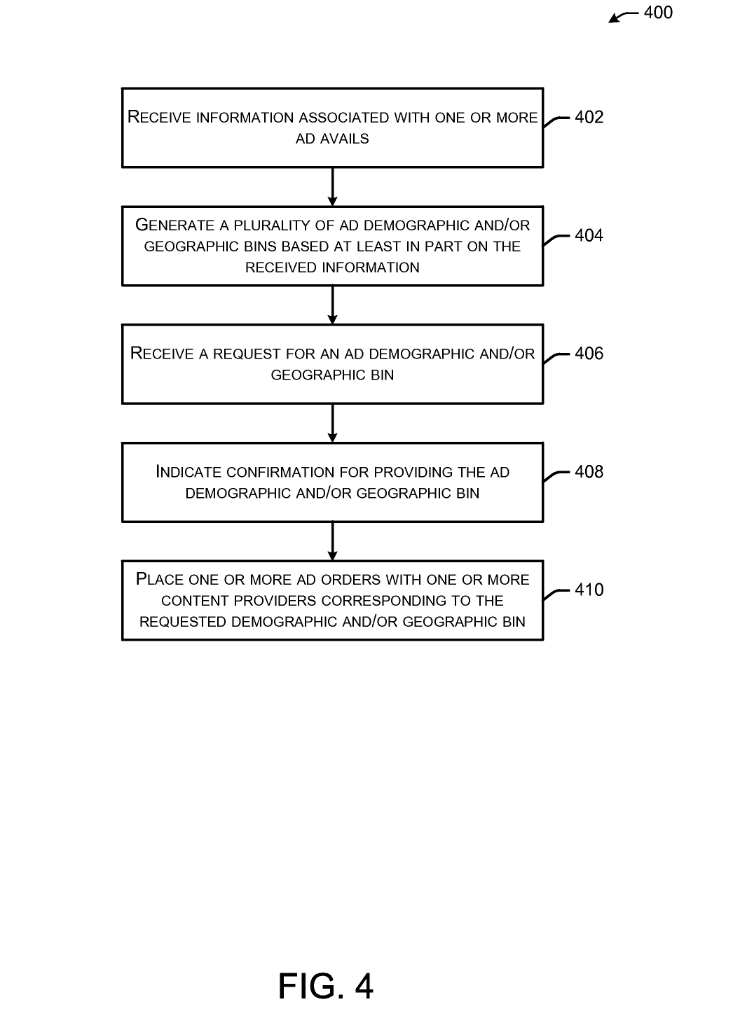

FIG. 4 is a flow diagram illustrating an example method 400 for providing ad demographic and/or geographic bins, in accordance with certain example embodiments of the disclosure. In certain example embodiments, the method 400 may be performed by the ad broker interconnect system 210 and the processors 300 thereon. The ad broker interconnect system 210, in performing the method 400, may interact with the ad broker 110 during one or more processes of method 400.

At block 402, information one or more ad avails may be received. These ad avail information may be received by the ad broker interconnect system 210 and the processors 300 thereon via one or more networks from the content providers 124, 230, 232 and/or associated content provider servers 240. In this case, the ad avails may be any variety of slots where ads may be inserted for rendering, including, but not limited to spots associated with the content providers 124, 230, 232. The ad avails may further include slots prior to, during, overlaid with, or after rendering streaming media, digital, and or video-on-demand (VOD) content.

At block 404, a plurality of demographic and/or geographic bins may be generated based at least in part on the received information of block 402. As described above, the ad avails may be combined to generate suitable ad demographic bins that may specify a variety of parameters such as numerical, demographical, and/or geographical parameters. The generation of this ad demographic bin may provide for interconnecting a variety of content provider platforms and/or geographies to provide a customized ad buying package and/or experience.

At block 406, a request for an ad demographic and/or geographic bin may be received. This may be received from an ad buyer 120 as a message, such as a message including one or more data packets, via his/her user device 220 and via one or more networks, such as the Internet. The request for the ad demographic bin may provide an identifier, such as a unique identifier, associated with the ad demographic bin. In some cases, the ad demographic request may include one or more parameters associated with the ad demographic bin

At block 408, a confirmation for providing the ad demographic and/or geographic bin may be indicated. This confirmation may be transmitted by the ad broker interconnect system 210 as a message, such as a message including one or more data packets, via one or more networks to the ad buyer's user device 220 and/or financial institution.

At block 410, one or more ad orders with one or more content providers corresponding to the requested demographic and/or geographic bin may be placed. These orders may be to purchase, on behalf of the ad demographic bin buyer, ad avails for rendering ads. These purchased ad avails may be used by the ad broker interconnect system 210 to meet the stipulated metrics and/or parameters associated with the sold ad demographic bin.

It should be noted, that the method 400 may be modified in various ways in accordance with certain embodiments of the disclosure. For example, one or more operations of method 400 may be eliminated or executed out of order in other embodiments of the disclosure. Additionally, other operations may be added to method 400 in accordance with other embodiments of the disclosure.

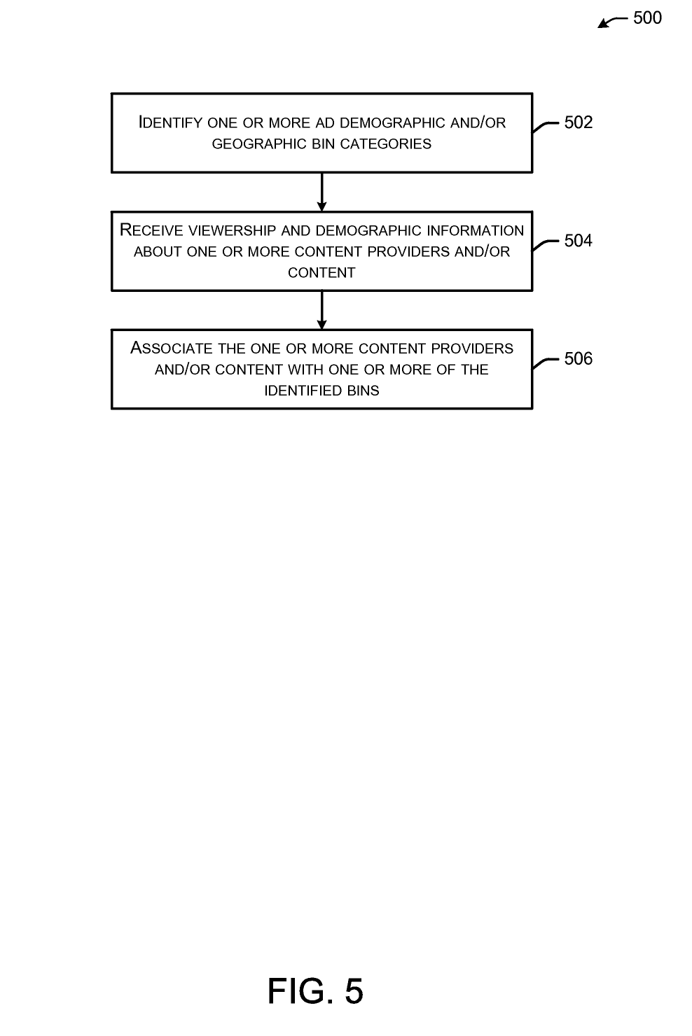

FIG. 5 is a flow diagram illustrating an example method 500 for generating one or more demographic and/or geographic bin, in accordance with certain example embodiments of the disclosure. Method 500 may be an example implementation of the process of block 404 of method 400 of FIG. 4, according to example embodiments of the disclosure. In certain example embodiments, the method 500 may be performed by the ad broker interconnect system 210 and the processors 300 thereon. The ad broker interconnect system 210, in performing the method 500, may interact with the ad broker 110 during one or more processes of method 500.

At block 502, one or more ad demographic and/or geographic bin categories may be identified. This identification may be by the ad broker 110 creating ad demographic bin categories and/or parameters. Ad brokers 110 may create these categories based on some knowledge and/or historical information related to ad asset inventories. Alternatively, demographical demand from ad buyers 120 for particular demographic targets may be used at least in part for creating ad demographic bin categories.

At block 504, viewership and demographic information about one or more content providers and/or content may be received. This viewership and demographic information may be received from the content providers 124, 230, 232 and associated content provider servers 240 or from third party sources, such as an aggregator and/or reporter of media-based statistics. This information may indicate demographical affiliation of viewers of the content. At block 506, the one or more content providers and/or content may be associated with one or more of the identified bins. This association may be based at least in part on determining efficient ways to provide the terms and/or parameters of the ad demographic bin. One or more algorithms may be used to determine optimized allocations of content and associated ad avails to particular ad demographic bins. These algorithms may include a variety of regression analysis, linear regression analysis, artificial intelligence algorithms, filtering algorithms, a variety of heuristics, principal component analysis, combinations thereof, or the like. The algorithms may further take into account the current and/or expected future prices of ad demographic bins and/or ad assets to be associated with the ad demographic bins.

It should be noted, that the method 500 may be modified in various ways in accordance with certain embodiments of the disclosure. For example, one or more operations of method 500 may be eliminated or executed out of order in other embodiments of the disclosure. Additionally, other operations may be added to method 500 in accordance with other embodiments of the disclosure.

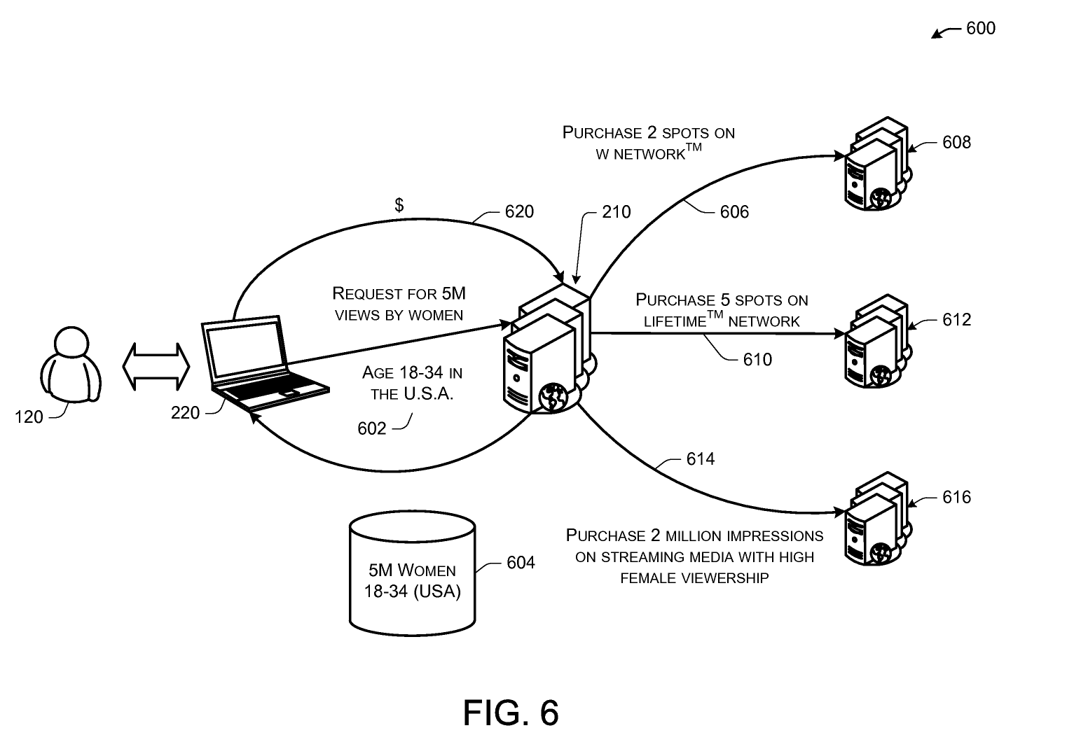

FIG. 6 is a schematic diagram illustrating an example environment 600 with an ad demographic bin sales transaction and advertising in according to the transacted demographic bin, in accordance with certain example embodiments of the disclosure. The transactions as displayed in environment 600 may be between one or more of the ad buyers 120 and their user devices 220, the content provider servers 240, and the ad broker interconnect system 210.

As depicted, the ad demographic bin sales transaction may entail a request for an ad demographic bin 602 transmitted from the user device 220 to the ad broker interconnect system 210. The request for the ad demographic bin 602 may be prompted by the ad buyer 120 by interacting with his/her user device 220. The request for the ad demographic bin 602 may, in certain example embodiments, be a message in the form of one or more data packets and transmitted to the ad broker interconnect system 210 via one or more communications networks.

In response to the request for the ad demographic bin 602, the ad broker interconnect system 210 may provide an indication of the sale of the ad demographic bin 604. Upon sales of the ad demographic bin 604 to the ad buyer 120, the ad broker interconnect system 210 may be obligated to perform to the parameters, such as numerical and demographical parameters of the ad demographic bin 602 that was sold to the ad buyer 120. In this case, the ad broker interconnect system 210 and the associated ad broker 110 may be obligated to provide 5 million views of one or more ads of the ad buyer 120 to a demographic group of women between the ages of 18 and 34 throughout the United States of America. In some example cases, the ad broker interconnect system 210 and/or the associated ad broker 210 may be contractually obligated to provide and/or perform to the parameters of the ad demographic bin 604 sold to the ad buyer.

To perform (i.e. provide the stipulated number of impressions to the target demographic) in accordance with the ad demographic bin 604 sold to the ad buyer 120 via his or her user device 220, the ad broker interconnect system 210 may acquire a plurality of spots and/or impressions on content provider systems (i.e. MSOs, broadcasters, digital/streaming media providers) via their respective content provider servers 608, 612, 616. In this case, the ad broker interconnect system 210 may acquire ad avails and/or assets associated with content that may primarily be consumed by the target demographic, namely women between the ages of 18-34 in the United States of America. Therefore, the ad broker interconnect system 210 may acquire ad assets associated with content that may appeal to the target demographic. In this example, the ad broker interconnect system 210 may acquire two spots on the W Network™ 606, five spots on the Lifetime Network™ 610, and two million impressions on streaming media content with high female viewership 616.

The ad assets 606, 610, 614 acquired by the ad broker interconnect system 210 on behalf of the ad buyer 120 may be used by the ad buyer to display one or more ads, such as ads related to a particular product or service. Upon performing to the terms of the ad demographic bin 604, the ad broker interconnect system 210 may receive payment 620 from the ad buyer 120. It will be appreciated that the ad broker interconnect system 210 serves as an interconnect for acquiring ad assets from a plurality of content distributers. In some cases this structure enables the efficient acquisition, deployment, and/or monetization of ad assets across a variety of different content distributers that may otherwise be geographically and/or demographically fragmented. It will further be appreciated that certain content providers, particularly broadcasters 232, may be relatively highly fragmented from a geographic standpoint. This geographic fragmentation may make it especially difficult for an ad buyer to acquire ad assets from these geographically fragmented content providers, such as broadcasters 232, in an efficient manner. It will be appreciated that the systems and methods as disclosed herein may enable a relatively efficient mechanism for acquire ad assets across a variety of geographically fragmented content providers 124, 230, 232.

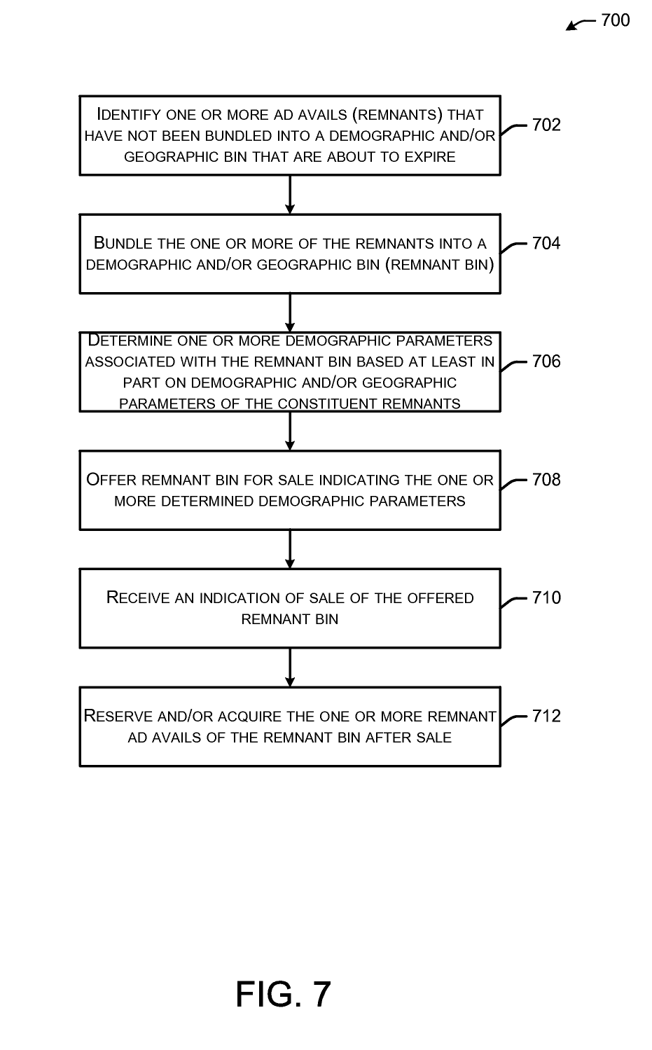

FIG. 7 is a flow diagram illustrating an example method 700 for remnant bundling and selling unbundled ad avails, in accordance with example embodiments of the disclosure. In certain example embodiments, the method 700 may be performed by the ad broker interconnect system 210 and the processors 300 thereon. The ad broker interconnect system 210, in performing the method 700, may interact with the ad broker 110 and/or the ad buyer 120 during one or more processes of method 700.

At block 702, one or more ad avails that have not been bundled into a demographic and/or geographic bin, referred to herein as a remnant ad avail, that is about to expire may be identified. Expiration, in this context, refers to the time associated with the remnant ad avail or the run time slot of the remnant ad avail. For example, in some non-limiting cases, if an ad avail has a time slot for the next day, then it may be determined, such as by the processors 300, that the ad avail is to imminently expire and therefore may be deemed a remnant ad avail that is to be presented to ad buyers 120 for sale. The ad avail may, therefore, be deemed about to expire if the run time slot of the ad avail meets a threshold condition. For example, if the difference between the run time of the ad avail and the current time is less than a predetermined threshold time, then it may be determined that the ad avail is to relatively imminently expire. As non-limiting examples, the predetermined threshold times may be one day, two days, one week, two weeks, or any suitable time threshold determined by any one of the ad broker system 210 and/or the content providers 124, 230, 232. In some cases, the predetermined threshold time may be different for ad avails from different content providers 124, 230, 232. In other alternative embodiments, the one or more remnant ad avails may be identified based at least in part on an indication received from one or more corresponding content providers 124, 230, 232 that the ad avails are indeed unsold and unbundled (i.e. not a constituent of an ad demographic bin) remnant ad avails.

At block 704, the one or more of the remnants may be bundled into a demographic and/or geographic bin, hereinafter referred to as a remnant bin. As in the case of the ad demographic bins, in some example embodiments, the remnant bins may be grouped to target particular demographic and/or geographic parameters that may be predicted to be saleable. In other example embodiments, the remnant bins may be created by randomly bundling available remnant ad avails. In yet other example embodiments, the remnant bins may be formed by grouping remnant ad avails that are likely to maximize revenue for the one or both of the ad broker 110 and/or the content providers 124, 230, 232.

It will be appreciated that in some example embodiments, due to the imminent expiration of the remnant ad avails, the content providers 124, 230, 232 may be relatively motivated to quickly sell the remnant ad avails. In some cases, the remnant ad avails may generate less revenue for the content providers 124, 230, 232 than would otherwise be the case if the ad avails were not to imminently expire. Bundling, the remnant ad avails into remnant bins may, in some cases, provide a better revenue realization overall for the content providers. In the same or other cases, bundling the remnant ads may provide for better pricing for the remnant ad avails. In other words, there may be situations where bundling of the remnant ad avails into remnant bins may result in a relatively advantageous situation for both the content provider (i.e. seller of the remnant ad avails) and the ad buyers 120. This situation may further result in relatively optimal usage of soon-to-expire ad assets.

At block 706, one or more demographic parameters associated with the remnant bin may be determined. The one or more demographic parameters associated with the remnant bin may be determined based at least on the demographic and/or geographic parameters associated with the constituent remnant ad avails. These demographic and/or geographic parameters of the remnant ad avails may be related to the viewership and/or geographic reach of the content and/or the content providers associated with the remnant ad avails. The demographic parameters of the remnant bin may be determined, in certain example embodiments, by aggregating, combining, and/or concatenating the one or more demographic and/or geographic parameters associated with constituent remnant ad avails of the remnant bins. The one or more demographic and/or geographic parameters of the constituent remnant ad avails may be received by the ad broker system 210 from the content providers 124, 230, 232 or from one or more third party sources, such as The Nielsen Company®.

At block 708, the remnant bin may be offered for sale, indicating the one or more determined demographic parameters of the remnant bin. The sales offer may be provided to the ad buyers 120 via their respective user devices 220. The sales offer in this case, may display the expected demographics parameters associated with the remnant bin offered for sale. In other cases, the sales offer may display guaranteed demographic parameters associated with the remnant bin offered for sale. As a non-limiting example, a particular remnant bin may be offered for sale indicating demographic parameters such as 100,000 views by women between 19 and 35 nationwide and 150,000 views by married men in New England. In some example embodiments, parameters associated with the constituent ad avails may be provided, such as run length and run time slot range. For example, the offer for sale may indicate that the ad avails are for run time slots over the next four days and each of the ad run times are to be 25 to 30 second spots. In some example embodiments, certain information pertaining to the remnant ad avails of the remnant bin may be withheld from the ad buyers 120 when the remnant bin is offered for sale. This information may, in certain example embodiments, include run time slots, content, and/or content providers 124, 230, 232 associated with each of the constituent remnant unsold ad avails that are bundled into the remnant bin.

At block 710, an indication of sale of the offered remnant bin may be received. This indication of sale may be received from an ad buyer 120 via his or her user device 220. In some cases, the indication of sale may be received along with payment for the remnant bin purchased by the ad buyer 120. At block 712, the one or more ad avails or remnants of the remnant bin may be reserved and/or acquired. These remnant ad avails may be acquired and/or reserved from the content providers 124, 230, 232.

It should be noted, that the method 700 may be modified in various ways in accordance with certain embodiments of the disclosure. For example, one or more operations of method 700 may be eliminated or executed out of order in other embodiments of the disclosure. Additionally, other operations may be added to method 700 in accordance with other embodiments of the disclosure.

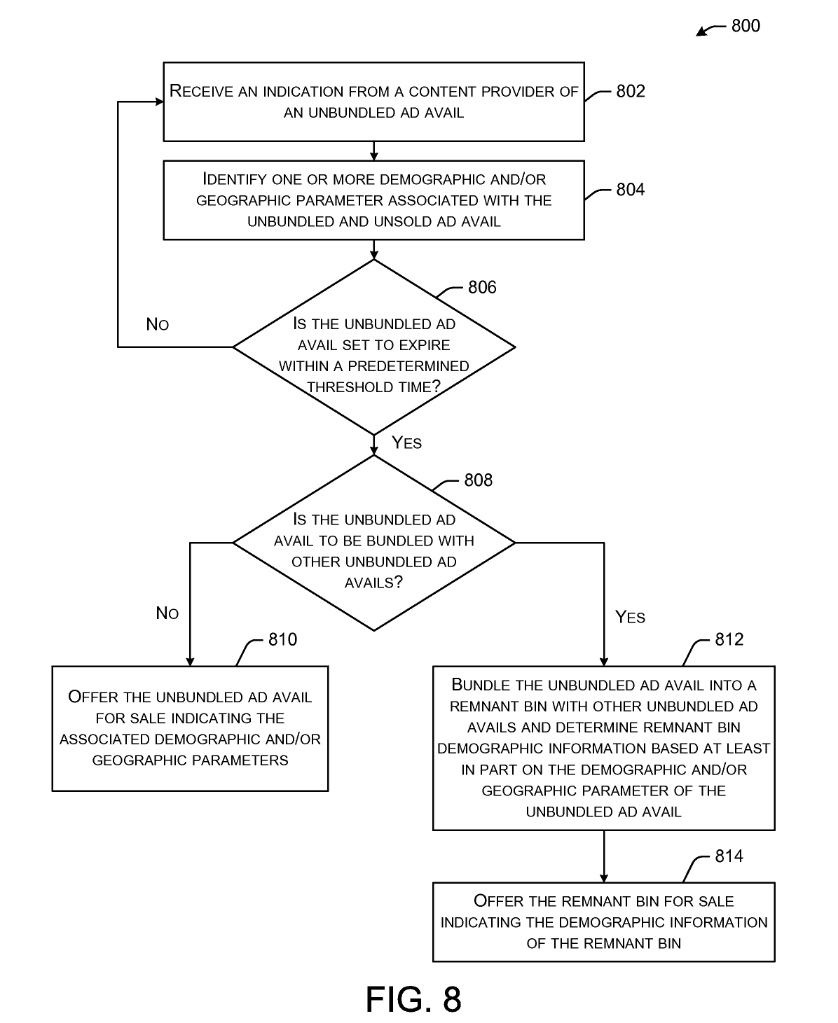

FIG. 8 is a flow diagram illustrating an example method 800 for receiving an indication of an unbundled ad avail and selling the ad avail, in accordance with example embodiments of the disclosure. In certain example embodiments, the method 800 may be performed by the ad broker interconnect system 210 and the processors 300 thereon. The ad broker interconnect system 210, in performing the method 800, may interact with the ad broker 110 and/or the ad buyer 120 during one or more processes of method 800.

At block 802, an indication may be received from a content provider of an unbundled and unsold ad avail. This indication of unsold ad inventory may, in certain embodiments, be provided by the content providers 124, 230, 232 as their ad avails approach expiration. In other cases, the soon-to-expire ad avails may be identified by the ad broker interconnect system and the processors 300 thereon based at least in part on an indication of all ad avails provided by the content providers 124, 230, 232 and knowledge of which ad avails have been bundled into ad demographic bins and/or sold to ad buyers 120.

At block 804, one or more demographic and/or geographic parameters associated with the unbundled ad avail may be identified. The one or more demographic and/or geographic parameters of the remnant ad avails may be received by the ad broker system 210 from the content providers 124, 230, 232 or from one or more third party sources, such as The Nielsen Company®.

At block 806, it may be determined if the unbundled ad avail is set to expire within a predetermined threshold time. In other words, it may be determined if the difference between the time of the ad avail and the current time is less than the predetermined threshold time. The predetermined threshold time may be any suitable value. In some non-limiting example, the predetermined threshold time may be one week. In other non-limiting examples, the predetermined threshold time may be two days. In yet other non-limiting examples, the predetermined threshold time may be one day.

If at block 806 if it is determined that the ad avail is not set to expire within the predetermined threshold time, then the method 800 may return to the process of block 802 to receive an indication of a further unbundled and unsold ad avail. In this case, the ad avail that is not set to expire within the predetermined threshold time may not be offered for sale at that current time and may be kept available for bundling into an ad demographic bin or sold as a non-remnant spot ad avail. If, however, at block 806, it is determined that the ad avail of the received indication is set to expire within the predetermined threshold time, then the method 800 may proceed to block 808 to determine if the unbundled and unsold ad avail is to be bundled with other unbundled ad avails.

If it is determined at block 808 that the ad avail is not to be bundled with other unbundled and unsold ad avails, then the method 800 may proceed to block 810 where the unbundled ad avail may be offered for sale, indicating the associated demographic and/or geographic parameters. The sales offer in this case, may display the expected demographics parameters associated with the ad avail offered for sale. In other cases, the sales offer may display guaranteed demographic parameters associated with the remnant bin offered for sale. As a non-limiting example, a particular ad avail may be offered for sale indicating demographic parameters such as 50,000 views by teenagers in the Southern United States. In some example embodiments, parameters associated with the ad avail may be provided, such as run length and run time slot range. For example, the offer for sale may indicate that the ad avail is for a run time slot sometime over the next four days and the ad run time may be a maximum of 43 seconds. In some example embodiments, certain information pertaining to the ad avail may be withheld form the ad buyers 120 when the remnant bin is offered for sale. This information may, in certain example embodiments, include run time slots, content, and/or content providers 124, 230, 232 associated with the ad avail.

If it is determined at block 808 that the unbundled ad avail is to be bundled with other unbundled ad avails, then the method 800 may proceed to block 808 where the unbundled ad avail is bundled with other unbundled ad avails to create a remnant bin. Furthermore, demographic information associated with the remnant bin may be determined based at least in part on the demographic and/or geographic parameters associated with the unbundled ad avail. These demographic and/or geographic parameters of the remnant ad avails may be related to the viewership and/or geographic reach of the content and/or the content providers associated with the remnant ad avails. The demographic parameters of the remnant bin may be determined, in certain example embodiments, by aggregating, combining, and/or concatenating the one or more demographic and/or geographic parameters associated with constituent remnant ad avails of the remnant bins.

At block 814, the remnant bin generated by the processes of block 812 may be offered for sale by indicating the demographic information of the remnant bin. The sales offer may be provided to the ad buyers 120 via their respective user devices 220. The sales offer in this case, may display the expected demographics parameters associated with the remnant bin offered for sale. In other cases, the sales offer may display guaranteed demographic parameters associated with the remnant bin offered for sale. In some example embodiments, parameters associated with the constituent ad avails may be provided, such as run length and run time slot range. For example, the offer for sale may indicate that the ad avails are for run time slots over the next four days and each of the ad run times are to be 25 to 30 second spots. In some example embodiments, certain information pertaining to the remnant ad avails of the remnant bin may be withheld from the ad buyers 120 when the remnant bin is offered for sale. This information may, in certain example embodiments, include run time slots, content, and/or content providers 124, 230, 232 associated with each of the constituent remnant unsold ad avails that are bundled into the remnant bin.

It should be noted, that the method 800 may be modified in various ways in accordance with certain embodiments of the disclosure. For example, one or more operations of method 800 may be eliminated or executed out of order in other embodiments of the disclosure. Additionally, other operations may be added to method 800 in accordance with other embodiments of the disclosure.

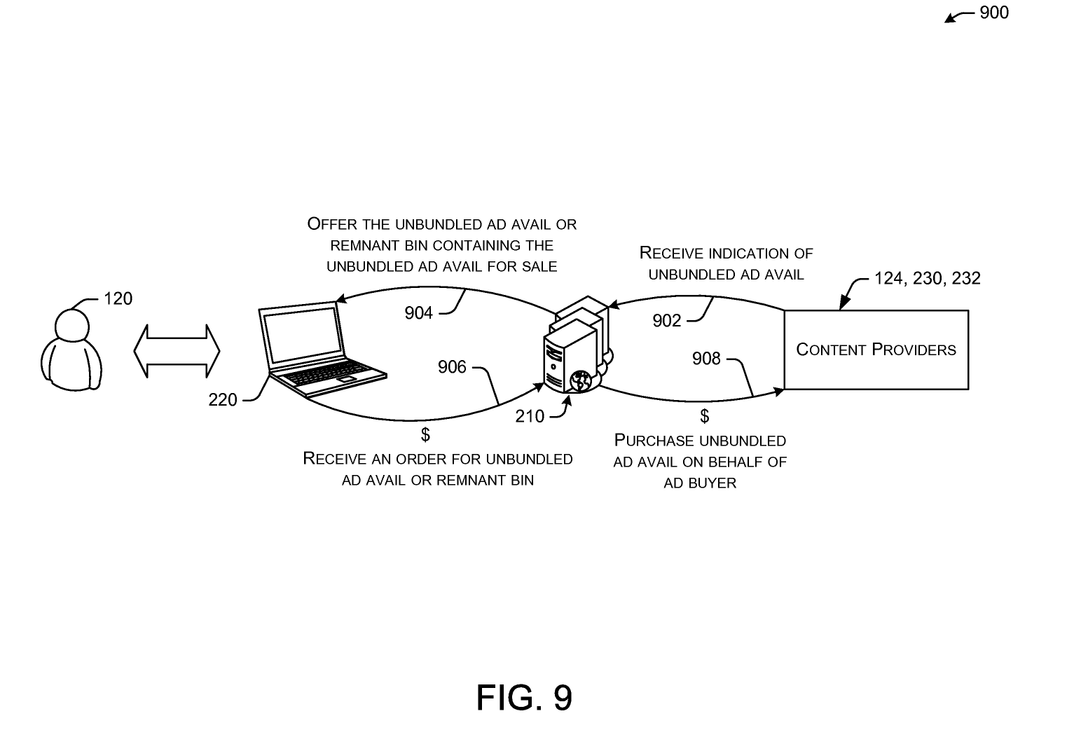

FIG. 9 is a schematic diagram illustrating and example environment for transacting an unbundled ad avail and/or remnant bin sale, according to example embodiments of the disclosure. The transactions as displayed in environment 900 may be between one or more of the ad buyers 120 and their user devices 220, the content provider servers 240, and the ad broker interconnect system 210. The ad broker interconnect system 210 may receive an indication 902 of an unbundled ad avail. In some example embodiments, the ad broker interconnect system 210 may also receive one or more demographic and/or geographic parameters associated with the unbundled ad avail while receiving an indication 902 thereof from the content providers 124, 230, 232. In some cases, the unbundled ad avail may be offered for sale 904 as an individual ad spot or may be bundled with other ad avails and offered for sale as a remnant bin to the ad buyer 120 via his/her user device 220. An order for the ad avail may be received 906. In some cases, the order may come with payment for the ad avail, either individually or as a bundled remnant bin. The ad broker interconnect system 210 may purchase and/or reserve 908 the ad avail on behalf of the ad buyer 120 upon receiving an order for the individual ad avail or as part of a remnant bin. In some cases, the purchase and/or reservation of the ad avail may entail transferring funds to the content providers 124, 230, 232.

Embodiments described herein may be implemented using hardware, software, and/or firmware, for example, to perform the methods and/or operations described herein. Certain embodiments described herein may be provided as one or more tangible machine-readable media storing machine-executable instructions that, if executed by a machine, cause the machine to perform the methods and/or operations described herein. The tangible machine-readable media may include, but is not limited to, any type of disk including floppy disks, optical disks, compact disk read-only memories (CD-ROMs), compact disk rewritable (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of tangible media suitable for storing electronic instructions. The machine may include any suitable processing or computing platform, device or system and may be implemented using any suitable combination of hardware and/or software. The instructions may include any suitable type of code and may be implemented using any suitable programming language. In other embodiments, machine-executable instructions for performing the methods and/or operations described herein may be embodied in firmware. Additionally, in certain embodiments, a special-purpose computer or a particular machine may be formed in order to identify actuated input elements and process the identifications.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

While certain embodiments of the invention have been described in connection with what is presently considered to be the most practical and various embodiments, it is to be understood that the invention is not to be limited to the disclosed embodiments, but on the contrary, is intended to cover various modifications and equivalent arrangements included within the scope of the claims. Although specific terms are employed herein, they are used in a generic and descriptive sense only, and not for purposes of limitation.

This written description uses examples to disclose certain embodiments of the invention, including the best mode, and also to enable any person skilled in the art to practice certain embodiments of the invention, including making and using any devices or systems and performing any incorporated methods. The patentable scope of certain embodiments of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The claimed invention is:

1. A method, comprising:
identifying, by an advertisement (ad) broker interconnect system comprising one or more processors, an expiration date of an unsold advertisement (ad) avail associated with a content provider;
identifying, by the ad broker interconnect system, one or more demographic parameters associated with the unsold ad avail;
determining, by the ad broker interconnect system and based at least in part on the expiration date, that the expiration date satisfies a threshold condition;
offering, by the ad broker interconnect system and based at least in part on determining that the expiration date satisfies a threshold condition, the unsold ad avail for sale on behalf of the content provider, wherein the offer for sale indicates at least one of the one or more demographic parameters associated with the unsold ad avail;
receiving, by the ad broker interconnect system responsive to the offer for sale, an indication of purchase of the unsold ad avail; and
reserving, by the ad broker interconnect system responsive to the indication of purchase, the unsold ad avail with the content provider on behalf of an ad buyer.

2. The method of claim 1, further comprising identifying the unsold ad avail by determining ad avails from a set of ad avails that have not been associated with a demographic bin or sold as a spot ad avail.

3. The method of claim 1, wherein identifying the one or more demographic parameters associated with the unsold ad avail comprises receiving the one or more demographic parameters from at least one of: (i) the one or more content providers or (ii) a third party source.

4. The method of claim 1, wherein the one or more demographic parameters include at least one of: (i) a target number of impressions; (ii) a target number of people in a viewers' household; (iii) a target gender of the viewers; (iv) a target age of the viewers; (v) a target age range of the viewers; (vi) a target race of the viewers; (vii) a target religion of the viewers; (viii) a target sexual orientation of the viewers; (ix) target political views of the viewers; (x) target product or service preferences of viewers; or (xi) a target geography of the viewers.

5. The method of claim 1, wherein identifying the one or more demographic parameters associated with the unsold ad avail comprises identifying one or more demographic parameters associated with a content associated with the unsold ad avail.

6. The method of claim 1, wherein determining that the expiration date satisfies a threshold condition comprises determining that a number of days from a current day to the expiration date is within a threshold number of days for unsold ad avails.

7. The method of claim 1, wherein receiving an indication of purchase of the unsold ad avail comprises receiving, by the ad broker interconnect system, a first payment from the ad buyer associated with the indication of purchase of the unsold ad avail.

8. The method of claim 1, wherein reserving the unsold ad avail with the content provider on behalf of an ad buyer comprises providing, by the ad broker interconnect system, a second payment to the content provider.

9. The method of claim 1, wherein offering the unsold ad avail for sale on behalf of the content provider comprises the offer for sale not indicating any of: (i) the content provider; (ii) a time slot of the unsold ad avail; or (iii) a content associated with the unsold ad avail.

10. The method of claim 1, wherein offering the unsold ad avail for sale on behalf of the content provider comprises:
bundling, by the ad broker interconnect system, the unsold ad avail with at least one second unsold ad avail to create a remnant bin;
determining, by the ad broker interconnect system, one or more demographic parameters associated with the remnant bin based at least in part on the one or more demographic parameters associated with the unsold ad avail and one or more demographic parameters associated with one or more of the at least one second unsold ad avail; and
offering, by the ad broker interconnect system, the remnant bin for sale, wherein the offer for sale indicates the one or more demographic parameters associated with the remnant bin.

11. The method of claim 10, wherein receiving an indication of purchase of the unsold ad avail comprises receiving an indication of purchase of the remnant bin.

12. One or more computer-readable media comprising computer-executable instructions that, when executed by one or more processors, configure the one or more processors to perform a method comprising:
receiving an indication of a plurality of available ad avails and respective corresponding one or more ad avail parameters;
determining that one or more of the plurality of ad avails are at least one of: (i) unsold, or (ii) unbundled into a demographic bin;
determining that at least one of the one or more of the plurality of ad avails are to be sold as remnant ad avails;
offering the remnant ad avails for sale, wherein the offer for sale indicates the respective corresponding one or more ad avail parameters of each of the remnant ad avails;
receiving, responsive to the offer for sale, an indication of purchase of a particular remnant ad avail of the remnant ad avails; and
reserving, responsive to the indication of purchase, the particular remnant ad avail with a content provider associated with the particular ad avail.

13. The one or more computer-readable media of claim 12, wherein offering the remnant ad avails for sale comprises the offer for sale not indicating any of: (i) a corresponding respective content provider associated with the remnant ad avails; (ii) a corresponding respective time slot of the remnant ad avails; or (iii) a corresponding respective content associated with the remnant ad avails.

14. The one or more computer-readable media of claim 12, wherein offering the remnant ad avails for sale comprises:
bundling at least two of the remnant ad avails as a remnant bin;
determining one or more demographic parameters associated with the remnant bin based at least in part on the respective corresponding one or more demographic parameters of each of the at least two of the remnant ad avails; and
offering the remnant bin for sale, wherein the offer for sale indicates the one or more demographic parameters associated with the remnant bin.

15. The one or more computer-readable media of claim 14, wherein receiving an indication of purchase of the particular remnant ad comprises receiving an indication of purchase of the remnant bin.

16. A system for providing advertisement avails, comprising:
at least one memory for storing computer-executable instructions;
at least one processor in communication with the at least one memory, wherein the at least one processor is configured to execute the computer-executable instructions perform a method comprising:
identifying an expiration date of an unsold advertisement (ad) avail associated with a content provider;
identifying one or more demographic parameters associated with the unsold ad avail;
determining, based at least in part on the expiration date, that the expiration date satisfies a threshold condition;
offering, based at least in part on determining that the expiration date satisfies a threshold condition, the unsold ad avail for sale on behalf of the content provider, wherein the offer for sale indicates at least one of the one or more demographic parameters associated with the unsold ad avail;
receiving, responsive to the offer for sale, an indication of purchase of the unsold ad avail; and
reserving, responsive to the indication of purchase, the unsold ad avail with the content provider on behalf of an ad buyer.

17. The system for providing advertisement avails of claim 16, wherein the method further comprises identifying the unsold ad avail by determining ad avails from a set of ad avails that have not been associated with a demographic bin or sold as a spot ad avail.

18. The system for providing advertisement avails of claim 16, wherein offering the unsold ad avail for sale on behalf of the content provider comprises the offer for sale not indicating any of: (i) the content provider; (ii) a time slot of the unsold ad avail; or (iii) a content associated with the unsold ad avail.

19. The system for providing advertisement avails of claim 16, wherein offering the unsold ad avail for sale on behalf of the content provider comprises:
bundling the unsold ad avail with at least one second unsold ad avail to create a remnant bin;
determining one or more demographic parameters associated with the remnant bin based at least in part on the one or more demographic parameters associated with the unsold ad avail and one or more demographic parameters associated with one or more of the at least one second unsold ad avail; and
offering the remnant bin for sale, wherein the offer for sale indicates the one or more demographic parameters associated with the remnant bin.

20. The system for providing advertisement avails of claim 19, wherein receiving an indication of purchase of the unsold ad avail comprises receiving an indication of purchase of the remnant bin.
